(19) United States
(12) Patent Application Publication
(10) Pub. No.: US 2005/0214015 A1
(43) Pub. Date: Sep. 29, 2005

(54) Densitometer for use in a printer

(75) Inventor: Kenneth P. Friedrich, Honeoye, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/034,586

(22) Filed: Jan. 13, 2005

Related U.S. Application Data
(60) Provisional application No. 60/556,176, filed on Mar. 25, 2004.

(51) Int. Cl. G03G 15/00

(52) U.S. Cl. 399/74

(57) ABSTRACT

A method and apparatus for a densitometer comprising a multicolor LED having a light adjustment mechanism for controlling the amount of light received by a light detector in the densitometer. The MCLED is comprised of a plurality of different color LEDs and a controller selects the current to each LED by wavelength to maximize the absorption by the colorant yielding light roughly complimentary to the colorant.

### RELATED APPLICATIONS

This application claims the priority of U.S. Provisional Application Ser. No. 60/556,176 filed Mar. 25, 2004 entitled “DENSITOMETER FOR USE IN A PRINTER”.

### FIELD OF THE INVENTION

This present invention relates to multiple-color image processing using inks or dry toners and, more specifically, to controlling the amount of ink or dry toner used in forming the image on a receiver.

### BACKGROUND

Conventional electrophotographic process steps employed within image processing equipment are known to employ light-emitting and light detection devices to measure the amount of toner used in image formation (e.g., U.S. Pat. Nos. 6,611,666; 5,325,153; 5,583,644; 5,842,080; and 6,055,011). Similarly, conventional printing processes used in image processing equipment are known to employ light-emitting and detection devices to measure the amount of inks used in the image formation (e.g., U.S. Pat. No. 5,854,680). The foregoing prior art references utilize light-emitting diodes (LEDs) in conjunction with photocells to quantify the amount of dry toner or ink used by measuring the amount of light reflected by image test patches. Specific attention is given to the very different light absorption and reflection characteristics of black vs. colored toner when illuminated with near infrared light. The use of other light sources, such as colored LEDs, is considered inferior due to higher cost and increased complexity in implementation (U.S. Pat. No. 6,055,011). Furthermore, in using reflected light to measure the quantity of dry toner or ink, the optical properties of the surface underneath have to be taken into consideration. These considerations might include the manufacture of intermediate transfer rollers with certain preferred optical characteristics (U.S. Pat. No. 5,842,080), switching of the illumination intensity to improve the signal-to-noise ratio (U.S. Pat. No. 5,325,153), or arranging image sample patches in support of a preferred measurement procedure (U.S. Pat. No. 5,854,680) and sequence.

Other disclosures within the prior art teach the use of light transmission through image test patches to measure the amount of colorant used in the image formation process. Such arrangements are described in JP-B 4-18310 (as referenced in U.S. Pat. No. 5,842,080, the original was not available to the authors) and in U.S. Pat. No. 5,903,800.

The previously discussed prior art disclosures (all of the disclosures of which are hereby incorporated by reference) measure the amount of toner used in the image formation process as an integral part of the image processing apparatus. Such measurements are used to derive control signals for the purpose of automatically adjusting the operating setpoints of the printing process itself so that printing quality is maintained and consistent over a large range of operating conditions and over long periods of print production.

Efforts regarding such systems have led to continuing developments to improve their versatility, practicality and efficiency.

### BRIEF DESCRIPTION OF THE DRAWINGS

FIGS. 1a-1b are schematic diagrams of an electrographic marking or reproduction system in accordance with the present invention;

FIG. 2 is a schematic diagram of a densitometer in accordance with the present invention;

FIG. 3 is a Table illustrating absorption characteristics of different colored toner patches for different color outputs of the MCLED; and

FIG. 4 is a flowchart of a method of controlling a development process using the MCLED of the present invention.

### DETAILED DESCRIPTION

The present invention provides hardware components, and the associated methods for their operation, that are particularly suited to be implemented in a multicolor printing process. The preferred embodiment of the invention utilizes an endless loop for recording the image, or transporting an image receiver on the endless loop. However, it is envisioned that other embodiments can also employ the components and methods of the present invention. Although the description of the preferred embodiments that follow are particularly suited for color printing, the present invention is also applicable to monochrome printing devices with accent color capability.

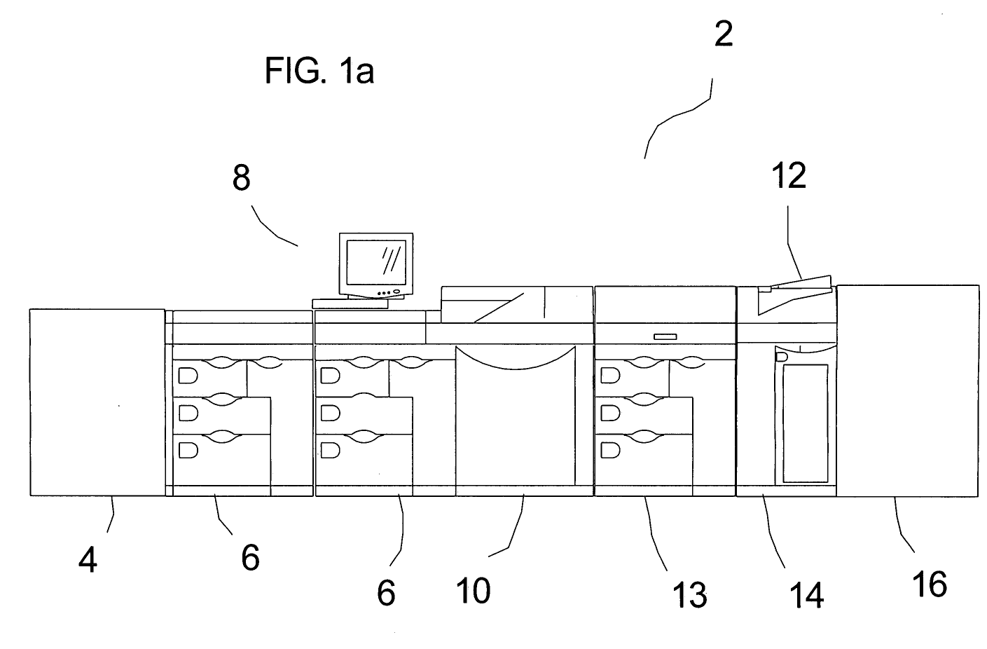

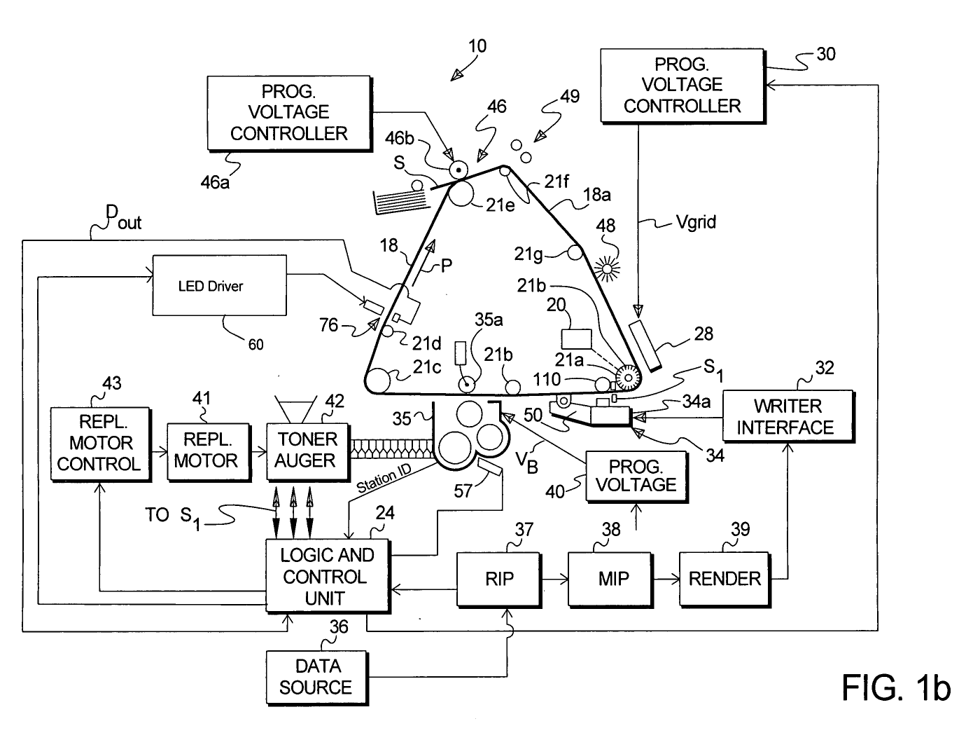

Referring now to FIG. 1a, wherein a print system 2 is comprised of a media treatment system 4 for treating media to be printed. The print system may be electrostatographic, ink jet, laser jet, or other type of printing device. Media may include paper, cardboard, plastic, metal sheets, or any of a number of materials to which a marking material is to be adhered to in a predefined pattern or image. The treated media is provided to a marking engine 10. Media to be printed on is also referred to as a receiver. For exemplary purposes, a media supply 6 is shown, wherein the treated media, and perhaps other media may be stacked in trays, finishing device, exited from the printer, or otherwise organized. The print system is controlled via a user interface 8 which may be remotely located from the print engine 10. The printed media is supplied to a stacking device 12, 14 and/or a finishing device 16.

Referring to FIG. 1b, the printer or marking engine 10 is an electrostatographic printer, and includes a moving recording member such as a photoconductive substrate configured in the shape of a belt or loop 18 which is entrained about a plurality of rollers or other supports 21a through 21g, one or more of which is driven by an advancing motor 20. By way of example, roller 21a is illustrated as being driven by motor 20. Motor 20 preferably advances the belt at a high speed in the direction indicated by arrow P past a series of workstations of the printer 10. Alternatively, belt 18 may be wrapped and secured about or configured as a single drum.

Printer 10 includes a controller or logic and control unit (LCU) 24, preferably a digital computer or microprocessor operating according to a stored program for sequentially actuating the workstations within printer 10, effecting overall control of printer 10 and its various subsystems. LCU 24 also is programmed to provide closed-loop control of printer 10 in response to signals from various sensors and encoders. Aspects of process control are described in U.S. Pat. No. 6,121,986 incorporated herein by this reference.

A primary charging station 28 in printer 10 sensitizes belt 18 by applying a uniform electrostatic corona charge, from high-voltage charging wires at a predetermined primary voltage, to a surface 18a of belt 18. The output of charging station 28 is regulated by a programmable voltage controller 30 (such as a high voltage power supply with a suitable controller), which is in turn controlled by LCU 24 to adjust this primary voltage, for example by controlling the electrical potential of a grid and thus controlling movement of the corona charge. Other forms of chargers, including brush or roller chargers, may also be used.

An exposure station 34 in printer 10 projects light from a writer 34a to belt 18. This light selectively dissipates the electrostatic charge on photoconductive belt 18 to form a latent electrostatic image of the document to be copied or printed. Writer 34a is preferably constructed as an array of light emitting diodes (LEDs), or alternatively as another light source such as a laser, flash lamp, or spatial light modulator. Writer 34a exposes individual picture elements (pixels) of belt 18 with light at a regulated intensity and exposure, in the manner described below. The exposing light discharges selected pixel locations of the photoconductor, so that the pattern of localized voltages across the photoconductor corresponds to the image to be printed. An image is a pattern of physical light which may include characters, words, text, and other features such as graphics, photos, etc. An image may be included in a set of one or more images, such as in images of the pages of a document. An image may be divided into segments, objects, or structures each of which is itself an image. A segment, object or structure of an image may be of any size up to and including the whole image.

Image data to be printed is provided by an image data source 36, which is a device that can provide digital data defining a version of the image. Such types of devices are numerous and include computer or microcontroller, computer workstation, scanner, digital camera, etc. These data represent the location and intensity of each pixel that is exposed by the printer. Signals from data source 36, in combination with control signals from LCU 24 are provided to a raster image processor (RIP) 37. The Digital images (including styled text) are converted by the RIP 37 from their form in a page description language (PDL) language to a sequence of serial instructions for the electrographic printer in a process commonly known as “ripping” and which provides a ripped image to an image storage and retrieval system known as a Marking Image Processor (MIP) 38.

In general, the major roles of the RIP 37 are to: receive job information from the server; parse the header from the print job and determine the printing and finishing requirements of the job; analyze the PDL (Page Description Language) to reflect any job or page requirements that were not stated in the header; resolve any conflicts between the requirements of the job and the marking engine configuration (i.e., RIP time mismatch resolution); keep accounting record and error logs and provide this information to any subsystem, upon request; communicate image transfer requirements to the marking engine; translate the data from PDL (Page Description Language) to raster for printing; and support diagnostics communication between user applications. The RIP accepts a print job in the form of a Page Description Language (PDL) such as PostScript, PDF or PCL and converts it into raster, a form that the marking engine can accept. The PDL file received at the RIP describes the layout of the document as it was created on the host computer used by the customer. This conversion process is called rasterization. The RIP makes the decision on how to process the document based on what PDL the document is described in. It reaches this decision by looking at the first 2K of the document. A job manager sends the job information to a MSS (Marking Subsystem Services) via Ethernet and the rest of the document further into the RIP to get rasterized. For clarification, the document header contains printer-specific information such as whether to staple or duplex the job. Once the document has been converted to raster by one of the interpreters, the Raster data goes to the MIP 38 via RTS (Raster Transfer Services); this transfers the data over a IDB (Image Data Bus).

The MIP functionally replaces recirculating feeders on optical copiers. This means that images are not mechanically rescanned within jobs that require rescanning, but rather, images are electronically retrieved from the MIP to replace the rescan process. The MIP accepts digital image input and stores it for a limited time so it can be retrieved and printed to complete the job as needed. The MIP consists of memory for storing digital image input received from the RIP. Once the images are in MIP memory, they can be repeatedly read from memory and output to the Render Circuit. The amount of memory required to store a given number of images can be reduced by compressing the images; therefore, the images are compressed prior to MIP memory storage, then decompressed while being read from MIP memory.

The output of the MIP is provided to an image render circuit 39, which alters the image and provides the altered image to the writer interface 32 (otherwise known as a write head, print head, etc.) which applies exposure parameters to the exposure medium, such as a photoconductor 18.

After exposure, the portion of exposure medium belt 18 bearing the latent charge images travels to a development station 35. Development station 35 includes a magnetic brush in juxtaposition to the belt 18. Magnetic brush development stations are well known in the art, and are preferred in many applications; alternatively, other known types of development stations or devices may be used. Plural development stations 35 may be provided for developing images in plural colors, or from toners of different physical characteristics. Accent color or process color electrographic printing is accomplished by utilizing this process for one or more of four or more toner colors (e.g., cyan, magenta, yellow and black (CMYK)). To this end, specialty color toner development stations may be provided to provide the ability to print specialty colors not normally attainable with typical CMYK mixtures. A sensor may be provided on each development station which identifies the station to the LCU via a Station ID line. In this manner, the LCU is notified of what colors toners are being utilized.

Upon the imaged portion of belt 18 reaching development station 35, LCU 24 selectively activates development station 35 to apply toner to belt 18 by moving backup roller 35a into engagement with belt 18 or close proximity to the magnetic brush. Alternatively, the magnetic brush may be moved toward belt 18 to selectively engage belt 18. In either case, charged toner particles on the magnetic brush are selectively attracted to the latent image patterns present on belt 18, developing those image patterns. As the exposed photoconductor passes the developing station, toner is attracted to pixel locations of the photoconductor and as a result, a pattern of toner corresponding to the image to be printed appears on the photoconductor. As known in the art, conductor portions of development station 35, such as conductive applicator cylinders, are biased to act as electrodes. The electrodes are connected to a variable supply voltage, which is regulated by programmable controller 40 in response to LCU 24, by way of which the development process is controlled.

Development station 35 may contain a two component developer mix which comprises a dry mixture of toner and carrier particles. Typically the carrier preferably comprises high coercivity (hard magnetic) ferrite particles. As an example, the carrier particles have a volume-weighted diameter of approximately 30 microns. The dry toner particles are substantially smaller, on the order of 6 microns to 15 microns in volume-weighted diameter. Development station 35 may include an applicator having a rotatable magnetic core within a shell, which also may be rotatably driven by a motor or other suitable driving means. Relative rotation of the core and shell moves the developer through a development zone in the presence of an electrical field. In the course of development, the toner selectively electrostatically adheres to photoconductive belt 18 to develop the electrostatic images thereon and the carrier material remains at development station 35. As toner is depleted from the development station due to the development of the electrostatic image, additional toner is periodically introduced by toner auger 42 into development station 35 to be mixed with the carrier particles to maintain a uniform amount of development mixture. This development mixture is controlled in accordance with various development control processes. Single component developer stations, as well as conventional liquid toner development stations, may also be used.

A transfer station 46 in marking engine 10 moves a receiver sheet S into engagement with photoconductive belt 18, in registration with a developed image to transfer the developed image to receiver sheet S. Receiver sheets S may be plain or coated paper, plastic, or another medium capable of being handled by printer 10. Typically, transfer station 46 includes a charging device for electrostatically biasing movement of the toner particles from belt 18 to receiver sheet S. In this example, the biasing device is roller 46b, which engages the back of sheet S and which is connected to programmable voltage controller 46a that operates in a constant current mode during transfer. Alternatively, an intermediate member may have the image transferred to it and the image may then be transferred to receiver sheet S. After transfer of the toner image to receiver sheet S, sheet S is detacked from belt 18 and transported to fuser station 49 where the image is fixed onto sheet S, typically by the application of heat. Alternatively, the image may be fixed to sheet S at the time of transfer.

A cleaning station 48, such as a brush, blade, or web is also located after transfer station 46, and removes residual toner from belt 18. A pre-clean charger (not shown) may be located before or at cleaning station 48 to assist in this cleaning. After cleaning, this portion of belt 18 is then ready for recharging and re-exposure. Of course, other portions of belt 18 are simultaneously located at the various workstations of marking engine 10, so that the printing process is carried out in a substantially continuous manner.

LCU 24 provides overall control of the print engine and various subsystems as is well known. LCU 24 will typically include temporary data storage memory, a central processing unit, timing and cycle control unit, and stored program control. Data input and output is performed sequentially through or under program control. Input data can be applied through input signal buffers to an input data processor, or through an interrupt signal processor, and include input signals from various switches, sensors, and analog-to-digital converters internal to marking engine 10, or received from sources external to marking engine 10, such from as a human user or a network control. The output data and control signals from LCU 24 are applied directly or through storage latches to suitable output drivers and in turn to the appropriate subsystems within marking engine 10.

Process control strategies generally utilize various sensors to provide real-time closed-loop control of the electrostatographic process so that marking engine 10 generates “constant” image quality output, from the user's perspective. Real-time process control is necessary in electrographic printing, to account for changes in the environmental ambient of the photographic printer, and for changes in the operating conditions of the printer that occur over time during operation (rest/run effects). An important environmental condition parameter requiring process control is relative humidity, because changes in relative humidity affect the charge-to-mass ratio Q/m of toner particles. The ratio Q/m directly determines the density of toner that adheres to the photoconductor during development, and thus directly affects the density of the resulting image. System changes that can occur over time include changes due to aging of the printhead (exposure station), changes in the concentration of magnetic carrier particles in the toner as the toner is depleted through use, changes in the mechanical position of primary charger elements, aging of the photoconductor, variability in the manufacture of electrical components and of the photoconductor, change in conditions as the printer warms up after power-on, triboelectric charging of the toner, and other changes in electrographic process conditions. Because of these effects and the high resolution of modern electrographic printing, the process control techniques have become quite complex.

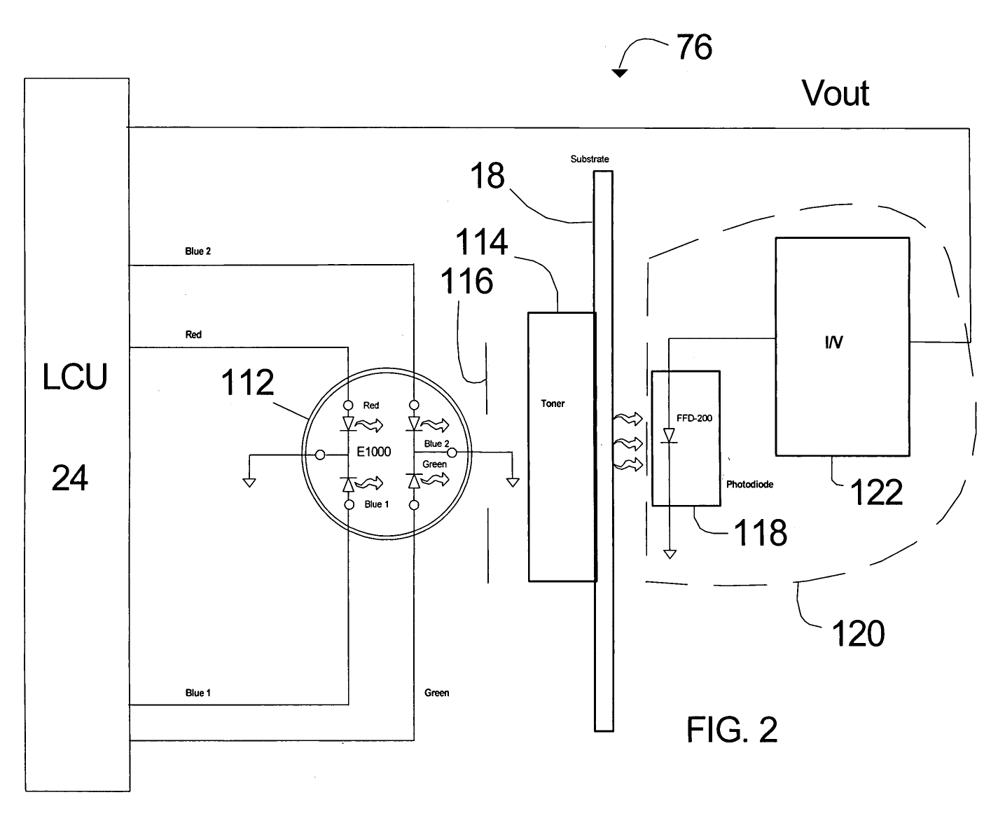

One such process control sensor is a densitometer 76, which monitors test patches (number 114 in FIG. 2) that are exposed and developed in non-image areas of photoconductive belt 18. LCU controls drivers 60 which provide variable current to LEDs in a densitometer 76 and may include infrared or visible light LEDs, which either shines through the belt or is reflected by the belt onto a photodiode in densitometer 76. These toned test patches are exposed to varying toner density levels, including full density and various intermediate densities, so that the actual density of toner in the patch can be compared with the desired density of toner as indicated by the various control voltages and signals. The densitometer measurements are used in a feedback loop to control a number of process parameters, such as primary charging voltage VO, maximum exposure light intensity EO, development station cylinder bias V_{B}, etc. In addition, the process control of a toner replenishment control signal value or a toner concentration setpoint value to maintain the charge-to-mass ratio Q/m at a level that avoids dusting or hollow character formation due to low toner charge, and also avoids breakdown and transfer mottle due to high toner charge for improved accuracy in the process control of marking engine 10. The toned test patches are formed in the interframe area of belt 18 so that the process control can be carried out in real time without reducing the printed output throughput. Another sensor useful for monitoring process parameters in printer 10 is electrometer probe 50, mounted downstream of the corona charging station 28 relative to direction P of the movement of belt 18. An example of an electrometer is described in U.S. Pat. No. 5,956,544 incorporated herein by this reference.

Other approaches to electrographic printing process control may be utilized, such as those described in International Publication Number WO 02/10860 A1, and International Publication Number WO 02/14957 A1, both commonly assigned herewith and incorporated herein by this reference.

Raster image processing begins with a page description generated by the computer application used to produce the desired image. The Raster Image Processor interprets this page description into a display list of objects. This display list contains a descriptor for each text and non-text object to be printed; in the case of text, the descriptor specifies each text character, its font, and its location on the page. For example, the contents of a word processing document with styled text is translated by the RIP into serial printer instructions that include, for the example of a binary black printer, a bit for each pixel location indicating whether that pixel is to be black or white. Binary print means an image is converted to a digital array of pixels, each pixel having a value assigned to it, and wherein the digital value of every pixel is represented by only two possible numbers, either a one or a zero. The digital image in such a case is known as a binary image. Multi-bit images, alternatively, are represented by a digital array of pixels, wherein the pixels have assigned values of more than two number possibilities. The RIP renders the display list into a “contone” (continuous tone) byte map for the page to be printed. This contone byte map represents each pixel location on the page to be printed by a density level (typically eight bits, or one byte, for a byte map rendering) for each color to be printed. Black text is generally represented by a full density value (255, for an eight bit rendering) for each pixel within the character. The byte map typically contains more information than can be used by the printer. Finally, the RIP rasterizes the byte map into a bit map for use by the printer. Half-tone densities are formed by the application of a halftone “screen” to the byte map, especially in the case of image objects to be printed. Pre-press adjustments can include the selection of the particular halftone screens to be applied, for example to adjust the contrast of the resulting image.

FIG. 2 is a schematic diagram of transmission type densitometer 76. A multi-color light emitting device (MCLED) 112 located on the outside of substrate 18 contains four light emitting diodes (LEDs) which emit light made of exemplary colors of Red, Blue 1, Blue 2, and Green. MCLED can provide a wide range of colors in the visible light spectrum by: a) varying which of the four LEDs (Red, Blue 1, Blue 2, Green) is turned on (i.e. provided drive current); and b) varying the amplitude of the drive current provided. Light from the MCLED could also be provided from a different number of LEDs than four operating at different colors than those shown, including LEDs emitting light outside the visible spectrum. The light emitted from the MCLED is passed through an aperture 116, through a patch of toner 114 disposed on substrate 18 and collected by a photodiode sensor 118 disposed on the inside of substrate 18. The light emitting device 112, emits light that is selected to maximize absorption by toner patch 112. The color of toner patch 112 is typically selected as a color being used in the printing process. The light emitted by device 112 is therefore selected as roughly or about the complementary of the color of the target toner patch 114. A complementary color is a color that, combined with the target color, makes white or black. Complementary colors are the diametrically opposed on the color circle. The ideal complementary color is the color of transmitted light which will have the maximum amount of absorption in the target toner patch, so that as the density of the patch increases, the amount of the transmitted light that is absorbed increases, and the amount of light reaching detector 118 decreases.

A conversion circuit 122 converts the output current response of the photodiode 118 to a voltage in a logarithmic operation. The logarithmic operation may be performed by specialized analog amplification devices (such as a. Burr-Brown Log100JP), or digital devices (such as microprocessors programmed accordingly). The amplitude of the output signal Vₒᵤₜ of such light detection section 120 can be expressed by Vₒᵤₜ=k*log (I._{light}/I._{ref}).

Conventionally, in image processing apparatus two light intensity measurements are performed, one without any colorant, a second in presence of colorant, to quantify the amount of colorant accurately without the error introduced otherwise by the support. The amount of colorant measured, M, is then determined by the difference of the two voltage measurements as shown by the relationship of Equation 1.
M=g*ΔV=g*(V₂−V₁)=g*k[log(I_{colorant}/I_{ref})−log(Iₛᵤₚₚₒᵣₜ/I_{ref})] Equation 1

The modifications made to the illumination, in accordance with the present invention, produce voltages V₁ and V₂ that are similar in magnitude for similar densities of colorants. Analogous, the constants g and k are similar, but not identical in value for each of the colorants.

Using the colored LEDs of the device in FIG. 2, the absorption characteristics of colorants used in an electrophotographic printing process are tabulated in Table 1. The absorption characteristic, according to the present invention, is measured with a light detection circuit and given as an output voltage of the detection circuit which produces an output voltage according to Vₒᵤₜ=k*log(_{light}/I_{ref}). The values listed in Tables 3 are the voltage differences ΔV=V₂−V₁, as defined by Equation 1. For the devices used in Table 3, the constant k was negative. Therefore, the voltages given are directly proportional to the amount of light absorbed by the colorant. Other circuits may be utilized to condition and interpret the output of photodiode 118.

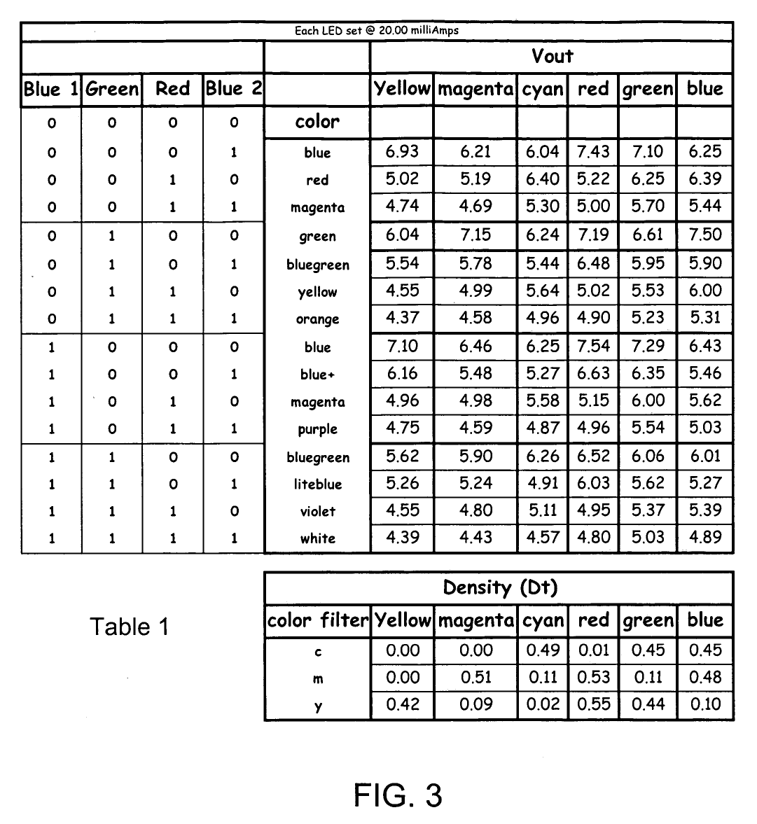

The table in FIG. 3 illustrates the capability of colorants cyan, magenta, and yellow to absorb light of different wavelengths. The four LEDs of device 112 are selectively turned on by a drive current of 20 milliamps as shown at the left of the table. The color column describes the color output of the MCLED, and the table on the right lists the absorption characteristics of the light emitted from the MCLED (in terms of output voltage Vₒᵤₜ from the photodiode circuit) when transmitted through yellow, magenta, cyan, red, green and blue. The densities of the yellow, magenta, cyan, red, green and blue test patches are shown at the bottom of FIG. 3. The highest value of Vₒᵤₜ represents the most amount of absorption. It can be seen in FIG. 3 the yellow patch has maximum light absorption when only the Blue 1 LED of the MCLED is turned on. A magenta test toner patch had maximum absorption when only the Green LED of the MCLED was turned on. A cyan test toner patch had maximum absorption when only the Red LED of the MCLED was turned on. Red, green and blue toner patches had maximum absorption when only the Blue 1 LED of the MCLED was turned on.

The light output of the MCLED in the densitometer 76 may be varied to obtain maximum sensitivity for all colors, so that a single densitometer may be used to measure toner density in a multicolor print engine. The densitometer 76 may be tuned to specific toner colors in a setup procedure or in process. To this end, the MCLED densitometer may be utilized to measure and determine both density and color of toner patches. If the response to a specific color patch is predetermined, verification of future deposited patches can be made by comparing the measured output to the expected or control output. Print engine process parameters (such as toner density and image color) may be controlled utilizing the feedback from such a densitometer.

The output voltage of the light-detecting section 120 is related to the light sensed by the light detector 118 by a logarithmic function, as defined by the conversion circuit 122. Such a relationship can be achieved by special integrated circuits, e.g., log-amplifiers produced by Burr Brown. However, it is also envisioned that a computational element, such as a microprocessor, can alternatively be employed to perform the logarithmic function. Such computational elements typically convert the analog signal from light detector 118 to a digital signal, processing it by implementation of a logarithmic algorithm, calculating the logarithm and converting the result back to an analog voltage.

Alternatively, the signal generated by light detector 118 can be converted into a digital word which can be used to address a Look Up Table which will, in turn, output data corresponding to a logarithmic function from the addressed memory cells within the Look Up Table. In any event, the use of a logarithmic function generator is preferred because human perception is logarithmic. There is a problem that exists using logarithmic functions in that these functions result in asymptotic outputs that, electronically, can cause problems to circuits that use the asymptotic outputs as inputs. Therefore, there exists a problem that requires special attention in order to prevent stages within the electrical circuitry following the logarithmic function from being damaged by these signals having asymptotic characteristics.

The present invention provides the ability to achieve improved accuracy and versatility in controlling a color print engine. Computer adjustment of the light output by means of automated control of the light emitter section allows repeated adjustments of the readings obtained without any colorant present. This is possible not only for the zero-density readings for all the colorants, but there is also the ability to measure the amount of colorants on various receivers such as papers and transparencies. Without any colorant present, the readings for V₁ (no colorant) are made in presence of the receiver only. The logic and control unit processes the readings Vₒᵤₜ such as to increase or decrease the light output by means of decreasing or increasing the control voltage to the light emitter. This adjustment procedure is applied conveniently whenever the image processing apparatus starts a production run. The correct timing for the measurements of V₁ and adjustments for control voltage are provided by the control program executed continuously in the logic and control unit.

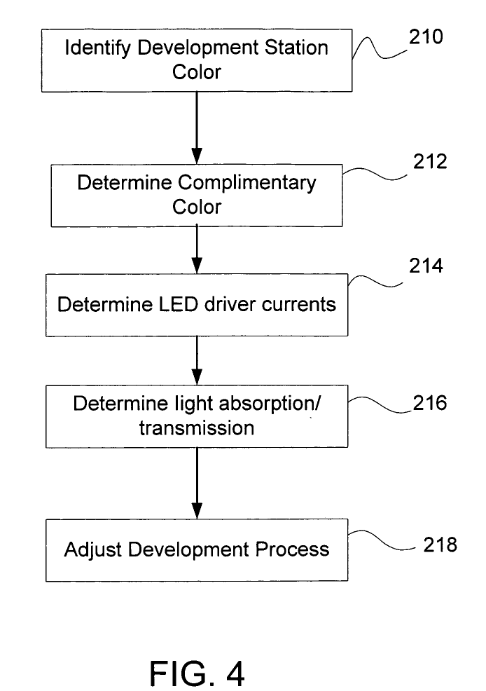

FIG. 4 is a flowchart of a method of controlling a development process using the MCLED of the present invention. In a step 210, the identity of the development station(s) to be utilized is determined. Each development station will have a specific color toner that it will deposit on the substrate. The present invention might utilize the MCLED for measuring density of a toner patch deposited by a singular development station, or a toner patch deposited by multiple stations. In this manner, the density of a wide variety of toner patch colors may be measured.

Once the target toner patch color is determined, the complimentary color for density measurement is determined in a step 212. This can be accomplished by using an algorithm, look up tables, or other techniques.

The appropriate LED drive currents for each LED in the MCLED to obtain the complimentary color light output of the MCLED are determined in a step 214.

In a step 216, the MCLED is provided the drive currents established in step 214 and the light measured by the photodiode is determined in a step 216. The output Vₒᵤₜ may be used to determine such things as toner patch density, or toner patch color.

In a step 218, the development process is adjusted in response to the determination made in step 216.

The MCLED of the present invention eliminates the need for multiple densitometers disposed discreetly throughout the printer. Having a singular densitometer for all colors is conducive to compactness and versatility for application in desktop printers and the like.

Although the invention has been shown and described with exemplary embodiments thereof, it should be understood by those skilled in the art that the foregoing and various other changes, omissions and additions may be made therein and thereto without departing from the spirit and scope of the invention.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

In view of the wide variety of embodiments to which the principles of the present invention can be applied, it should be understood that the illustrated embodiments are exemplary only, and should not be taken as limiting the scope of the present invention. For example, the steps of the flow-diagrams may be taken in sequences other than those described, and more, fewer or other elements may be used in the block diagrams.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

1. A densitometer used in color image processing comprising:
depositing an image on a substrate;
a light emitter comprising a plurality of light emitting sources of differing colors for impinging light on the image;
a light detector positioned opposite the light emitter to detect light that passes through the image; and
a controller for controlling the light output of the light emitting sources to thereby control the color of the light emitter output for optimum response of the light detector to the light emitter output.

2. The densitometer of claim 1, wherein the light emitter output is a predetermined wavelength selected to maximize absorption by a colorant being sensed.

3. The densitometer of claim 2, wherein the output light is a predetermined wavelength representative of a color that is complimentary to the colorant being sensed.

4. The densitometer of claim 1, wherein the controller controls the amount of current provided to the light emitting sources.

5. The densitometer of claim 1, wherein the light emitting sources are LEDs.

6. The densitometer of claim 1, further comprising the step of controlling the deposition of the image onto the substrate as a function of the detected light.

7. A method of controlling color image processing comprising:
depositing an image on a substrate;
blending the light output of a plurality of different colored light emitting sources and impinging the combined light onto the image;
detecting the amount of combined light that passes through the image; and
controlling the light output of the light emitting sources to thereby control the color of the combined light output for optimum detection response.

8. The method of claim 7, further comprising the step of controlling the depositing of the image on the substrate as a function of detected light.

9. The method of claim 7, wherein the light output is a predetermined wavelength selected to maximize absorption by a colorant being sensed.

10. The method of claim 9, wherein the output light is a predetermined wavelength representative of a color that is complimentary to the colorant being sensed.

11. The method of claim 7, wherein the controlling step controls the amount of current provided to the light emitting sources.

12. The method of claim 7, wherein the light emitting sources are LEDs.

13. A method of controlling color image processing comprising:
depositing an image on a substrate;
blending the light output of a plurality of different colored light emitting sources and impinging the combined light onto the image;
detecting the amount of combined light that passes through the image; and
controlling the light output of the light emitting sources to thereby control the color of the combined light output for optimum detection response.

14. The method of claim 13, further comprising the step of controlling the depositing of the image on the substrate as a function of detected light.

15. The method of claim 13, wherein the light output is a predetermined wavelength selected to maximize absorption by a colorant being sensed.

16. The method of claim 15, wherein the output light is a predetermined wavelength representative of a color that is complimentary to the colorant being sensed.

17. The method of claim 16, wherein the controlling step controls the amount of current provided to the light emitting sources.

18. The method of claim 17, wherein the light emitting sources are LEDs.
